(19) United States
(12) Patent Application Publication
(10) Pub. No.: US 2007/0044443 A1
(43) Pub. Date: Mar. 1, 2007

(54) Multiple integrated-layer ceramic fiber filter paper and method

(76) Inventors: Richard D. Nixdorf, Knoxville, TN (US); Michael J. Smith, Knoxville, TN (US)

Correspondence Address: DOUGLAS T. JOHNSON;MILLER & MARTIN, 1000 VOLUNTEER BUILDING, 832 GEORGIA AVENUE, CHATTANOOGA, TN, 37402-2289, US

(21) Appl. No.: 11/512,902

(22) Filed: Aug. 30, 2006

Related U.S. Application Data
(63) Continuation-in-part of application No. 60/712,569, filed on Aug. 30, 2005.

(51) Int. Cl. B01D 39/20; B01D 39/02; D04H 1/16

(52) U.S. Cl. 55/523; 55/527; 264/113

(57) ABSTRACT

A composition of a multiple-layered ceramic fiber filter paper and method for manufacturing for use in a filter apparatus removes particulate from high temperature gas streams. In this application, ceramic fibers of varying diameters and lengths are combined in such a manner to yield different specific average pore sizes in segregated locations in the filter paper. The fiber combinations are formed into a paper sheet using a method that produces two or three porosity zones with different average pore sizes in each layer or porosity zone. The porosity gradient from large at gas stream entry to fine at gas stream exit increases particle-holding capacity while reducing the filtered gas backpressure experienced in single sized porosity layer media.

### CLAIM OF PRIORITY

This application claims the benefit of U.S. Provisional Patent Application No. 60/712,569 filed Aug. 30, 2005.

### BACKGROUND OF THE INVENTION

Filter media formed from single layer sheets of ceramic fibers and the use of such ceramic fiber media in filters may be used for the extraction of volatile and non-volatile particulate from high-temperature exhaust gas streams. These filters are principally used to clean particulate emissions from the exhaust of diesel engines, coal-fired steam plants that generate electricity, and high-temperature industrial manufacturing processes. The ceramic fiber can withstand the high operating temperature of the exhaust stream and trap combustible particulate in a low temperature exhaust, then, withstand the temperature excursion from an auxiliary heat source, resulting in high regeneration temperatures to clean the filter cartridge.

The papermaking and filter manufacturing processes for ceramic fiber media require very different and unique processes from cellulose. The low temperature cellulose and polymeric fibers are hydrophilic; therefore, easy to disperse in the water during the papermaking process. These fibers are fabricated into cartridges with near-room-temperature manufacturing processes. The ceramic fiber is hydrophobic, thereby using innovative dispersion prior to papermaking and fiber flow to the papermaking screen to achieve uniform fiber dispersion during the water-based papermaking process. Ceramic fibers tend to agglomerate and settle out of the papermaking slurry onto the forming screen in an irregular sheet. Filter fabrication manufacturing, using the ceramic fiber paper media, is accomplished at processing temperatures of over 1,000° C. Therefore, previous processes in the use of cellulose and polymer fibers do not lend themselves to ceramic fiber media and filter cartridge manufacturing.

Prior art in ceramics has shown success in making ceramic fiber paper media. U.S. Pat. No. 6,582,490 discloses a method to manufacture a filter cartridge using a single layer, single porosity ceramic fiber filter media paper. U.S. Patent Publication No. 2003/0165638 A1 discloses a method to make single layer, single porosity ceramic fiber filter media paper, then converting to a filter cartridge with improved ceramic binders to make the filter cartridge durable. Both disclosed technologies produce a filter media that is durable in use. The particulate loading capacity of these single-layer ceramic fiber filters is significantly less than the extruded ceramic honeycomb filters, which are the current industrial standard for hot gas particulate filters. The filter surface area of the ceramic fiber filters is a fraction of the extruded ceramic honeycomb filters. The ceramic fiber filters, with a single layer fine porosity, accumulate particulate on the filter media surface, as do the extruded honeycomb filters. Therefore, the surface area advantage of the extruded honeycomb filters exhibits superiority in filtration properties.

U.S. Pat. No. 6,585,788 discloses the use of a two-layer ceramic fiber filter media with a separate coarse entry layer and a finer exit layer. The two separate layers of media porosity are joined during the filter fabrication process along a boundary interface.

### SUMMARY OF THE INVENTION

Accordingly, in one exemplary embodiment, a multiple-porosity zone ceramic fiber filter media is provided. Layers having porosity zones of different average pore sizes may be used by combining fiber diameters and lengths for each porosity zone to establish the specified pore size for that respective porosity zone, at the required sequence during the papermaking process. Different porosity zones may be integrated by adjusting the papermaking process such that there may be no discernible separation or boundary between the various porosity zones of differing porosity and instead a porosity gradient exists intermediate the porosity zones where they meet.

In one exemplary embodiment of the present invention, high temperature ceramic fibers from the group consisting of aluminum oxide, alumino-silicate, mullite, and silicon carbide are selected according to their fiber diameter. Ceramic fibers in a group with diameters from about 3 to about 20 microns are designated for processing to form the large porosity gas entry porosity zone. Ceramic fibers in the group with diameters from about 1 to about 6 microns are designated for processing to form the fine porosity exit porosity zone. An organic fiber such as natural cellulose or a man-made polymeric fiber is selected to binder the ceramic fibers together during the papermaking process to provide a continuous “green” sheet capable of moving through the take-off rolls and drying rolls of a commercial papermaking machine.

Manufactured ceramic fibers are received in tightly-held bundles. Ordinary papermaking, consisting of one type of ceramic fiber and one type of binder fiber, can be dispersed in a single attrition type mixing vat using a single dispersion chemistry. One exemplary embodiment uses multiple fiber species and sizes. Each fiber species may require a unique dispersion chemistry. The different fibers are, therefore, preferably dispersed in multiple single attrition type mixing vats using their respective optimum dispersion chemistries. Upon completion of the fiber bundle dispersion for each fiber type, the ceramic fibers for the coarse porosity zone entry are combined with the first-stage binder fibers in a first-stage feed to the head-box to be mixed and distributed on the papermaking vacuum screen cloth to form the coarse porosity zone of the filter media. Ordinary papermaking would continue to remove water from this sheet by means of additional vacuum, then, move to the drying rolls to finish the sheet formation process.

In an exemplary embodiment of this invention, the free water is not removed after the first porosity zone is formed. Instead, more water is added to the coarse porosity zone sheet to maintain a disturbed and roughened exposed upper surface. The individually dispersed smaller ceramic fibers used for the fine porosity exit porosity zone are introduced to a second head-box or a secondary feed to the primary head-box, downstream from the coarse-porosity zone head-box. These smaller fibers are distributed on top of the coarse porosity zone to the specified thickness. A strong vacuum is applied after the small fiber distribution to influence integrated combination of the porosity zones. This two-layer, two porosity zone filter media paper then moves to a take-off roll and into the drying rolls to result in a finished filter media paper.

The particular features and advantages of the invention will become apparent from the following description taken in connection with the accompanying drawings in which:

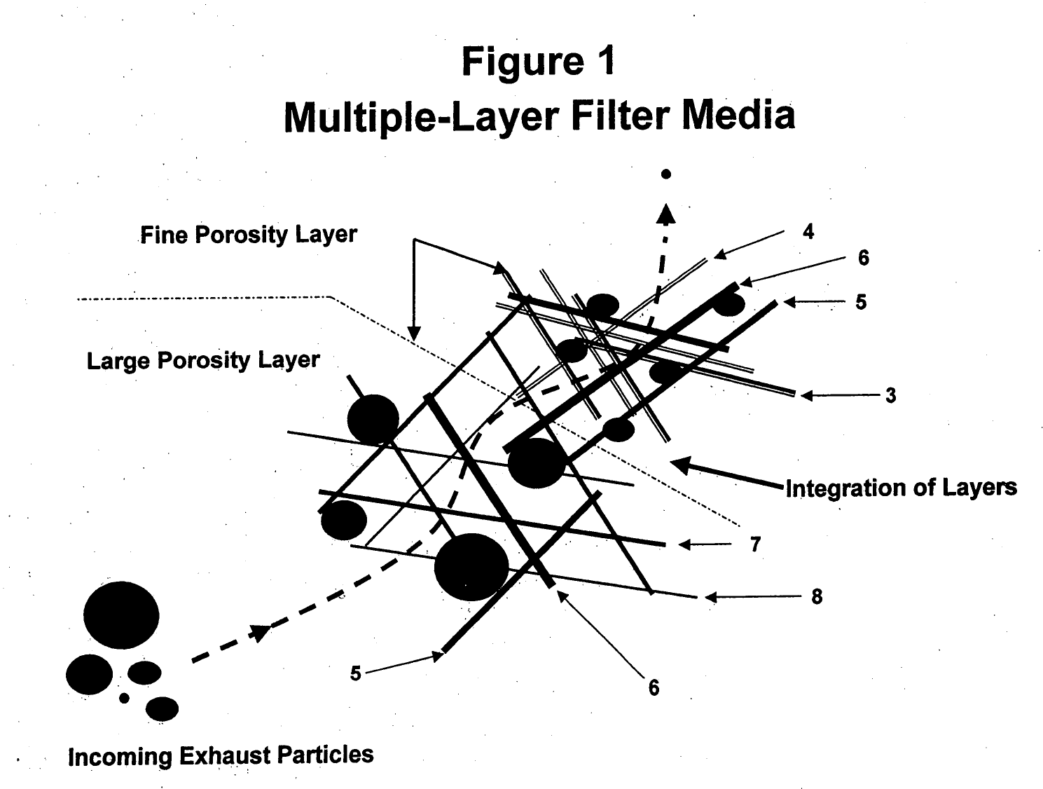

FIG. 1 is a schematic of a presently preferred embodiment of the multiple-layer filter media embodying various of the features of the present invention;

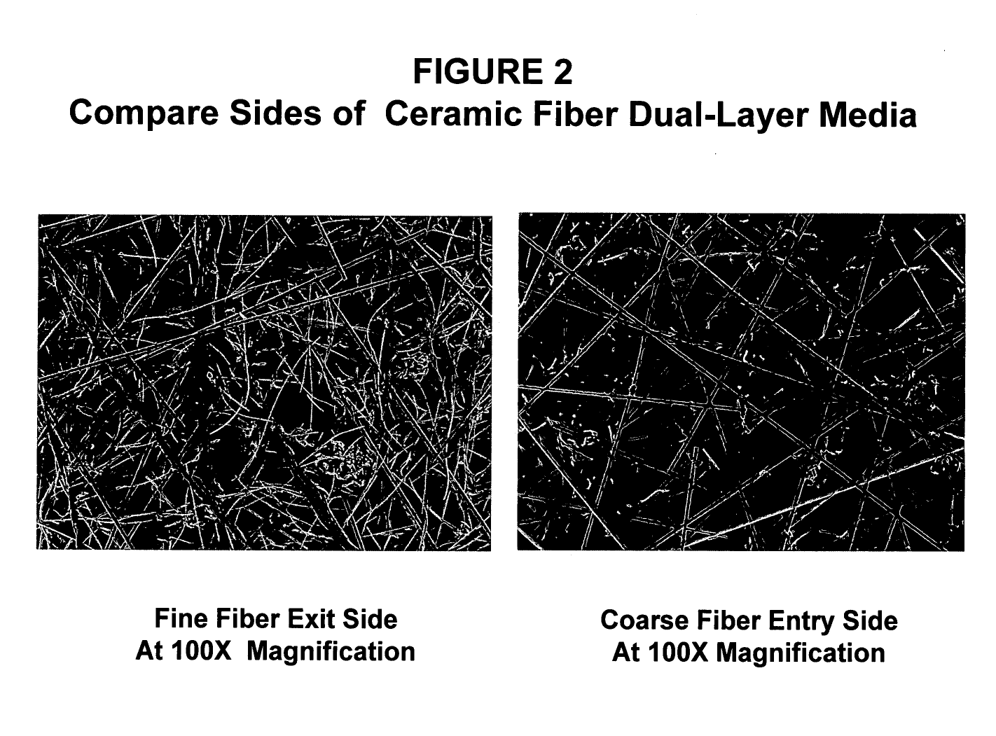

FIG. 2 is a scanning electron micrograph of the entry and exit porosity zone surfaces of the preferred embodiment at 100× magnification;

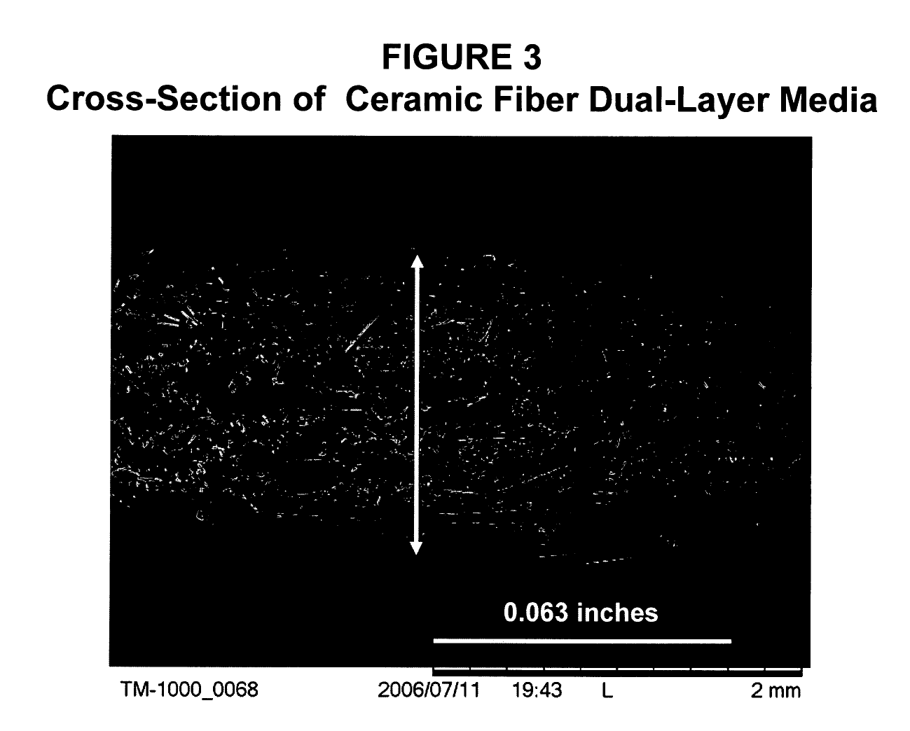

FIG. 3 is a scanning electron micrograph of a cross-section of the dual-layer ceramic fiber filter media of FIG. 2 at 80× magnification showing the boundary-free nature of the two porosity zones;

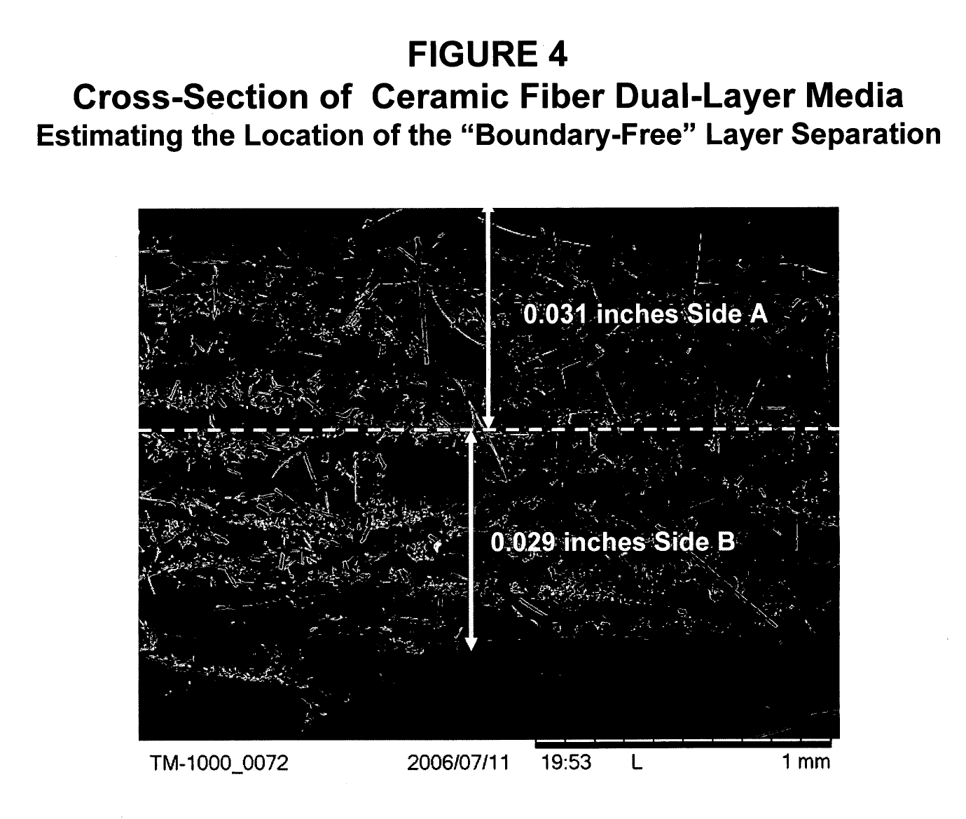

FIG. 4 is a scanning electron micrograph of a cross-section of the dual porosity zone ceramic fiber filter media of FIGS. 2 and 3 at 80× magnification estimating the location of the boundary between the coarse and the fine porosity zones;

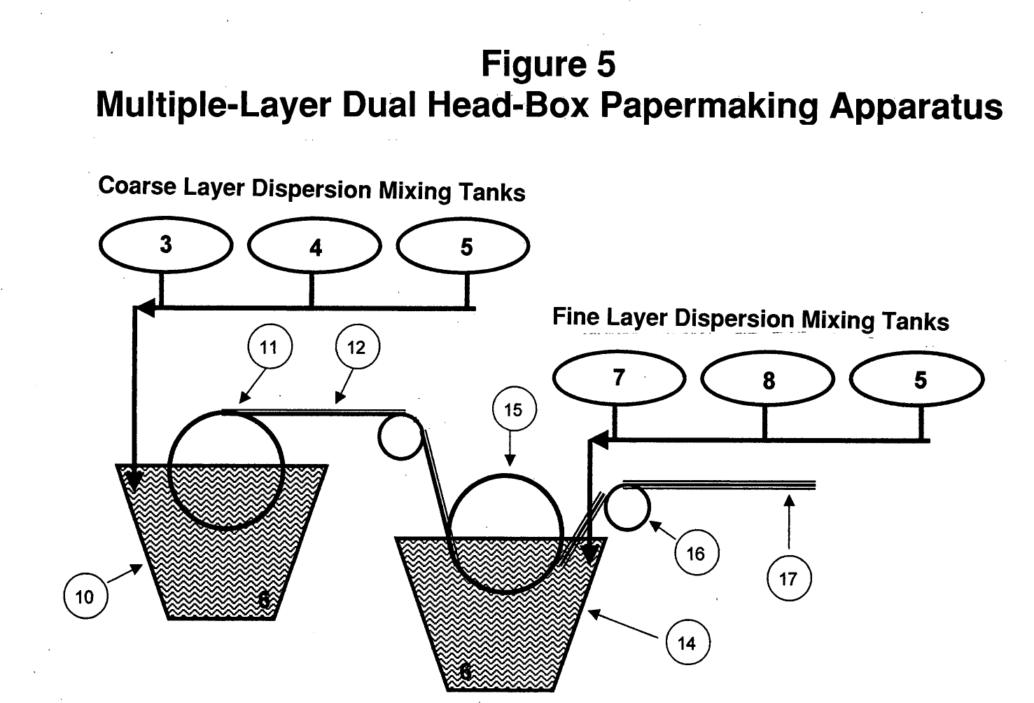

FIG. 5 is a representation of a papermaking apparatus utilized to manufacture the multiple-porosity zone filter media using a dual head-box in a presently preferred embodiment; and

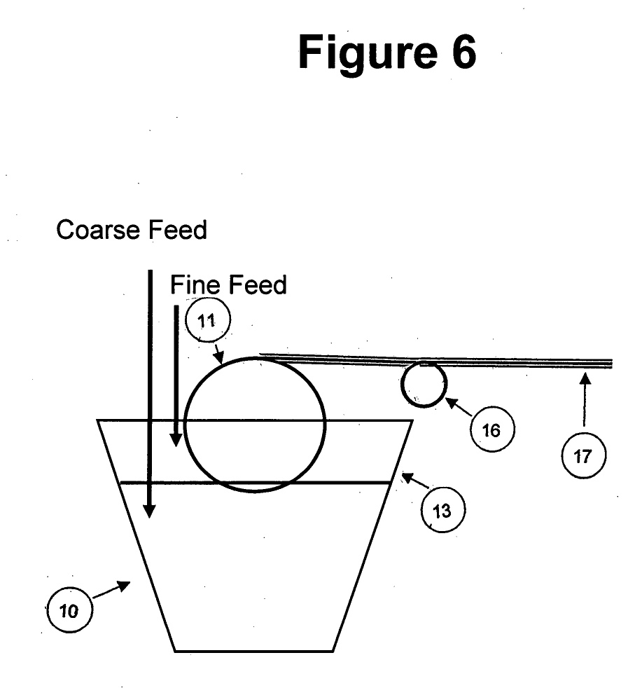

FIG. 6 is a representation of a paper making apparatus using a dual channel feed in a single head-box of an alternatively preferred manufacturing method.

### DETAILED DESCRIPTION OF THE INVENTION

Although the present invention is herein described in terms of specific embodiments, it will be readily apparent to those skilled in this art that various modifications, rearrangements, and substitutions can be made without departing from the spirit of the invention. The scope of the present invention is thus only limited by the claims appended hereto and the equivalents thereof.

An exemplary embodiment of the present invention provides a multiple-layer or multiple porosity zone ceramic fiber based filter media paper that exhibits a gradient porosity and the integration of individual boundary-free porosity zones to form a single sheet paper media. Differing strength and durability characteristics may be obtained through the selected use of various high-temperature ceramic fiber diameters and lengths formed in various papermaking process. In an exemplary embodiment, the ceramic fiber-based web is characterized by low-density, low backpressure, high strength and particle trapping efficiencies exceeding 95%. One skilled in the art will understand variations of such characteristics may be employed. In one exemplary embodiment, the porosity zones comprise material having generally different average porosities from each other. The gradient porosity may be a non stepwise change in porosity, such as linear or gradual, from one zone to another.

Referring to FIG. 1, an exemplary embodiment of a high porosity first or inlet layer material has been prepared by mixing 25.6% of Nextel 610 aluminum oxide ceramic fiber (10 microns in diameter) 7 in an attrition vat with 9.5 pH ammonium hydroxide in 128 parts of water for one hour. The Nextel fiber is added to a second mixing vat with 6.4% Zircar ALBF aluminum oxide fiber (3 microns in diameter) 8 and 7.7% Silocon Carbide fiber such as one disclosed in U.S. Pat. No. 6,767,523 (10-16 microns in diameter) 5, with 10.3% refined soft pine cellulose 6 and diluted to 200 parts water. Other first or entrance porosity zone material compositions as are known in the art could be used and/or substituted including but not limited to glass and/or other ceramic materials depending upon the particular end-use application. The first layer porosity zone mixture is fed onto a single or dual-channel head-box 10 to be fed to the well-known Roto-Former 11 or delta-former screen wire process to form the bottom paper sheet 12. Other processes as are known in the art could also be utilized to form the bottom paper sheet 12.

In an exemplary embodiment, an exit or second porosity zone was formed by mixing 25.2% of Saffil 3D aluminum oxide fibers (6 micron diameter) 3, 6.3% of Saffil RF aluminum oxide fibers (3 micron diameter) 4, 8% Silicon Carbide fibers such as one disclosed in U.S. Pat. No. 6,767,523 (10-16 microns diameter) 5, and 10.5% refined soft pine cellulose 6. Add the Saffil 3D and the Saffil RF to 166 parts water and attrition mill for 10 minutes. Dilute to 290 parts water. Add the Silicon Carbide fiber and agitate for 30 minutes. Other formulations of fine porosity exit porosity zones as are known in the art could also be employed including but not limited to glass and/or other ceramic materials depending upon the particular end-use application. The fine porosity exit or second porosity zone is preferably fed on top of the formed entry layer in a second head-box as shown in FIG. 5 or a second channel of a dual channel feed as shown in FIG. 6. A perforated metal separator 13 is shown in FIG. 6.

The fine porosity mixture can then be distributed on the coarse porosity, roughened sheet, by a Roto-Former 15. The two head-boxes may be directly adjacent and fed sequentially to a vacuum-former wire papermaking mechanism; or maybe one head-box with sequential dual-channel feeds. The subsequent vacuum box 16 pressure can be increased to pull the two porosity zones together in an integrated manner, in the form of a pressure gradient such as could be done without forming an interface bonding discernable to the naked eye to form the gradient porosity. Then the dual-layer sheet of filter media 17 can then continue through the standard steps of dewatering and drying for an ordinary papermaking process. Other pressure related methods can be utilized to “join” the dual layers together.

Although only two different average porosity zones, fine porosity layer and large porosity layers are illustrated in FIG. 1 meeting at a porosity gradient, it would be obvious to one skilled in the art that more than two layers can be provided (with more than one gradient). Furthermore, although “coarse” or “first” is the inlet and “fine” is described as outlet porosity zones, other arrangements could be provided. Additionally, gradual changes from one porosity zone to another may be provided in other embodiments while integrating porosity zones together. It may be possible for three, four, or even more porosity zones to be integrated for various applications.

Numerous alterations of the structure herein disclosed will suggest themselves to those skilled in the art. However, it is to be understood that the present disclosure relates to the preferred embodiment of the invention which is for purposes of illustration only and not to be construed as a limitation of the invention. All such modifications which do not depart from the spirit of the invention are intended to be included within the scope of the appended claims.

Having thus set forth the nature of the invention, what is claimed herein is:

1. A multiple layer ceramic fiber filter paper for high temperature particulate filtration: comprising:
at least a first and a second porosity zones having different average porosities, said first and second porosity zones having selected weight percentage combinations of high temperature resistant ceramic fibers, wherein said first and second layers are joined together along a porosity gradient intermediate the first and second porosity zones.

2. The filter paper of claim 1 wherein the first porosity zone is at least partially formed before forming the second porosity zone, and at least a portion of the second porosity zone extends a depth into at least a portion of the first porosity zone while at least a portion of the second porosity zone extends above the at least partially formed first porosity zone.

3. The filter paper of claim 1 wherein a thickness intermediate distal portions of the first and second porosity zones is in a range of about 0.75 mm to about 2.54 mm.

4. The filter paper of claim 1 wherein the average porosities of the first and second porosity zones are created based on a selection of average diameter and length properties of ceramic fibers selected for use in the respective first and second porosity zones.

5. The filter paper of claim 1 wherein the second porosity zone porosity is fine enough to remove at least 85% of particulate from a fluid stream directed through both the first and second porosity zones.

6. The filter paper of claim 5 wherein the fluid steam is from a group of diesel engine exhaust, coal fired steam plant exhaust and industrial manufacturing process output.

7. The filter paper of claim 1 formed by the process of:
selecting ceramic fibers for use in the first porosity zone to provide a first average porosity for the first porosity zone;
selecting ceramic fibers for use in the second porosity zone to provide a second average porosity for the second porosity zone;
at least partially forming the first porosity zone as a portion of a filter paper;
forming the second porosity zone into at least a portion of the first porosity zone to provide the porosity gradient.

8. The filter paper of claim 7 wherein a pressure differential is utilized to assist in forming the second porosity zone into the first porosity zone.

9. The filter paper of claim 7 wherein a first head box is utilized to form the first porosity zone and a second head box is utilized to form the second porosity zone relative to the first porosity zone.

10. The filter paper of claim 7 wherein a single head box is utilized to form the first porosity zone and the second porosity zone is formed on the first porosity zone.

11. The filter paper of claim 2 formed by the process of:
selecting ceramic fibers for use in the first porosity zone to provide a first average porosity for the first porosity zone;
selecting ceramic fibers for use in the second porosity zone to provide a second average porosity for the second porosity zone;
at least partially forming the first porosity zone as a portion of a filter paper;
forming the second porosity zone into at least a portion of the first porosity zone to provide the porosity gradient.

12. The filter paper of claim 1 wherein the ceramic fibers selected for the second porosity zone have an average species fiber diameter in a range of about 1 to about 6 microns.

13. The filter paper of claim 12 wherein the ceramic fibers selected for the first porosity zone have an average species fiber diameter in a range of about 3 to about 20 microns.

14. The filter paper of claim 1 wherein the second porosity zone has an average porosity greater than a largest particle anticipated to be entrapped by the filter paper.

15. A method of manufacturing a multiple layer ceramic fiber filter paper comprising the steps of:
selecting ceramic fibers for use in a first porosity zone to provide a first average porosity for the first porosity zone;
selecting ceramic fibers for use in a second porosity zone to provide a second average porosity for the second porosity zone, wherein said first and second porosity zones have different average porosities;
at least partially forming the first porosity zone as a portion of a filter paper;
forming the second porosity zone into at least a portion of the first porosity zone before the first porosity zone is completely formed to provide the ceramic fiber filter with a porosity gradient intermediate the first and second porosity zones.

16. The method of claim 15 wherein after forming the first and second porosity zones, at least a portion of the second porosity zone extends a depth into at least a portion of the first porosity zone while at least a portion of the second porosity zone extends above the at least partially formed first porosity zone.

17. The method of claim 15 further comprising the steps of forming the first porosity zone in a first head box feed and the second porosity zone in a second head box feed.

18. The method of claim 15 further comprising the step of forming the first porosity zone in a head box with a first feed and a second porosity zone in the head box with a second feed.

19. The method of claim 15 further comprising the step of forming the first porosity zone as a portion of a filter paper and then forming the second porosity zone on the first porosity zone.

20. The method of claim 15 wherein the second porosity zone is formed on top of the first porosity zone and a vacuum pressure is utilized to at least assist in forming the second porosity zone into the first porosity zone.
